(19) United States
(12) Patent Application Publication
(10) Pub. No.: US 2022/0234525 A1
(43) Pub. Date: Jul. 28, 2022

(54) VEHICLE-MOUNTED CHARGER

(71) Applicant: Shenzhen Junkaida Intelligent Technology Co., Ltd, Shenzhen (CN)

(72) Inventors: Liangliang Ji, Liuyang, Hunan (CN); Yuanbing Xu, Nanchang (CN)

(21) Appl. No.: 17/717,124

(22) Filed: Apr. 10, 2022

Related U.S. Application Data
(63) Continuation of application No. PCT/CN2019/125362, filed on Dec. 13, 2019.

(30) Foreign Application Priority Data
Oct. 29, 2019 (CN) 201921834400.7

(51) Int. Cl. B60R 16/02; H01R 13/02; H01R 13/428; H02J 7/00

(52) U.S. Cl. CPC B60R 16/02; H02J 7/00; H01R 13/428; H01R 13/02

(57) ABSTRACT

The application provides a vehicle-mounted charger, comprising a shell, a charging interface, a circuit board and a handle, wherein the shell is capable of being completely inserted into a power taking port of a vehicle-mounted power supply, the charging interface is embedded into a first end of the shell, the circuit board is mounted in the shell and is connected with the charging interface, the first end of the shell is provided with a locking slot, the handle is rotatably arranged at the first end and is capable of being completely moved in and clamped into the locking slot or being moved out from the locking slot via its own rotation, and the first end is an end of the shell deviated from the power taking port.

### CROSS REFERENCE TO RELATED APPLICATIONS

The present application is a Continuation application of PCT Application No. PCT/CN2019/125362 filed on Dec. 13, 2019, which claims the priority of Chinese Patent Application No, 201921834400.7 filed on Oct. 29, 2019 and entitled ‘vehicle-mounted charger’ in the Patent Office of the People's Republic of China, the entire disclosure of which is incorporated herein by reference.

### TECHNICAL FIELD

The application relates to the technical field of vehicle-mounted charging and relates to a vehicle-mounted charger.

### BACKGROUND

A vehicle-mounted charger is an accessory which is convenient for a vehicle owner to charge electronic products at all times and places with a vehicle-mounted charging power supply.

As a shell of a conventional vehicle-mounted charger often protrudes out of an end surface of an inlet end of a power taking port after being inserted into the power taking port of a vehicle-mounted power supply and it is hard for a handle to better fit the shell so as to store and hide the handle because the handle and the shell of the vehicle-mounted charger are usually mounted in a separated manner, a user is unable to better seal the power taking port of the vehicle-mounted power supply via a cover body when not using the vehicle-mounted charger, and thereby, huge hidden dangers are brought to safe use of the vehicle-mounted power supply.

### Technical Problem

The application is mainly intended to provide a vehicle-mounted charger to solve the technical problem that the power taking port of the vehicle-mounted power supply cannot be better sealed via the cover body under a condition of an existing vehicle-mounted charger.

### Technical Solution

A vehicle-mounted charger includes a shell, a charging interface, a circuit board and a handle, where the shell is capable of being completely inserted into a power taking port of a vehicle-mounted power supply, the charging interface is embedded into a first end of the shell, the circuit board is mounted in the shell and is connected with the charging interface, the first end of the shell is provided with a locking slot, the handle is rotatably arranged at the first end and is capable of being completely moved in and clamped into the locking slot or being moved out from the locking slot via its own rotation, and the first end is an end of the shell deviated from the power taking port; the handle is provided with a first connecting portion, an axle hole passes through the first connecting portion, a connecting shaft passes through the axle hole, and two ends of the connecting shaft pass through two opposite sides of the first end.

The present invention has the beneficial effects:

As the shell is designed to be capable of being completely inserted into the power taking port of the vehicle-mounted power supply, it is ensured that the shell will not protrude out of the end surface of the inlet end of the power taking port when being inserted into the power taking port; moreover, the first end of the shell is provided with the locking slot, the handle is rotatably arranged at the first end and is capable of being completely moved in and clamped into the locking slot or being moved out from the locking slot via its own rotation, and the user is able to drive the handle to rotate via an external force, so that the handle is moved out from the locking slot when it is required to use and is completely moved in and clamped into the locking slot without protruding out of the end surface of the first end of the shell when it is not required to use, and therefore, the handle is stored and hidden conveniently. Thus, it is ensured that the user is able to better seal the power taking port by fitting the cover body and the end surface of the inlet end of the power taking port when not using the vehicle-mounted charger, thereby overcoming the potential safety hazards of the vehicle-mounted power supply in use. The handle is provided with the first connecting portion which can increase the connecting area between the handle and the first end, so that it is labor-saving and safe. Furthermore, the sense of beauty of the whole structure formed by assembling the vehicle-mounted charger and the vehicle-mounted power supply can be further enhanced.

### BRIEF DESCRIPTION OF DRAWINGS

FIG. 1 is a structure diagram of a vehicle-mounted charger of the application.

FIG. 2 is a cutaway view of a vehicle-mounted charger in an embodiment of the application.

FIG. 3 is a structural schematic diagram of a vehicle-mounted charger and a vehicle-mounted power supply assembled in an embodiment of the application.

FIG. 4 is a structural schematic diagram of a conductive clip in a vehicle-mounted charger in an embodiment of the application.

10—vehicle-mounted charger; 100—charger body; 110—shell; 112—locking hole; 114—locking slot; 120—charging interface; 200—circuit board; 20—vehicle-mounted power supply; 21—power taking port; 22—power connecting portion; 300—conductive clip; 310—connecting sheet; 320—supporting leg; 322—first supporting portion; 324—second supporting portion; 330—convex block; 400—conductive head; 500—handle; 600—connecting shall; 700—indicatinglamp.

### DETAILED DESCRIPTION OF EMBODIMENTS

It should be understood that the specific examples described herein are merely used for explaining the disclosure, instead of limiting the disclosure.

One of the core concepts of the application is as follows: as the shell 110 is designed to be capable of being completely inserted into the power taking port 21 of the vehicle-mounted power supply 20, it is ensured that the shell 110 will not protrude Out of the end surface of the inlet end of the power taking port 21 when being inserted into the power taking port 21; moreover, the first end of the shell 110 is provided with the locking slot 114, the handle 500 is rotatably arranged at the first end and can be completely moved in and clamped into the locking slot 114 via its rotation or can be moved out from the locking slot 114, and the user is able to drive the handle to rotate via an external force, so that the handle 500 is moved out from the locking slot 114 when it is required to use and is completely moved in and clamped into the locking slot 114 without protruding out of the end surface of the first end of the shell 110 when it is not required to use, and therefore, the handle 500 is stored and hidden conveniently. Thus, it is ensured that the user is able to better seal the power taking port 21 by fitting the cover body and the end surface of the inlet end of the power taking port 21 when not using the vehicle-mounted charger 10, thereby overcoming the potential safety hazards of the vehicle-mounted power supply 20 in use. The handle 500 is provided with the first connecting portion which can increase the connecting area between the handle 500 and the first end, so that it is labor-saving and safe. Furthermore, the sense of beauty of the whole structure formed by assembling the vehicle-mounted charger 10 and the vehicle-mounted power supply 20 can be further enhanced.

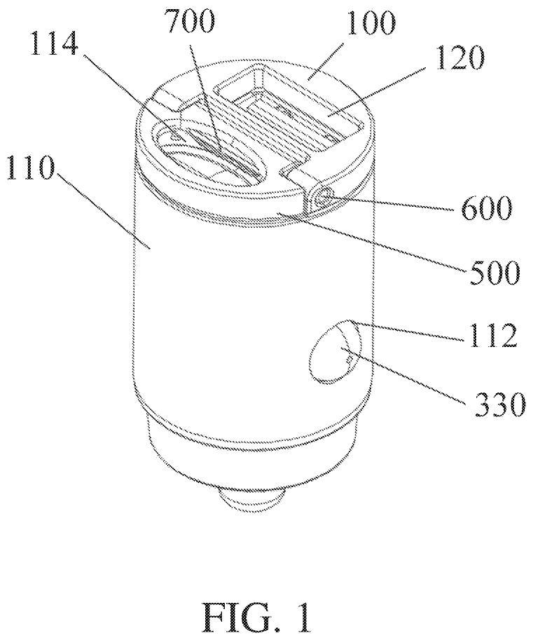

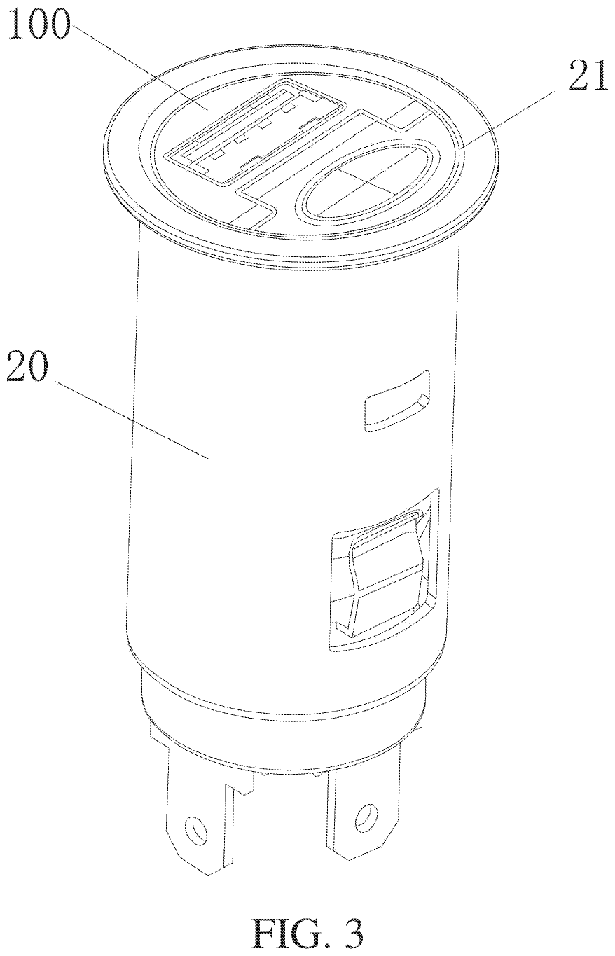

Referring to FIG. 1 to FIG. 3, provided is vehicle-mounted charger 10, specifically including a shell 110, a charging interface 120, a circuit board 200 and a handle 500, where the shell 110 can be completely inserted into a power taking port 21 of a vehicle-mounted power supply 20, the charging interface 120 is embedded into a first end of the shell 110, the circuit board 200 is mounted in the shell 110 and is connected with the charging interface 120, the first end of the shell 110 is provided with a locking slot 114, the handle 500 is rotatably arranged at the first end and can be completely moved in and clamped into the locking slot 114 via its rotation or can be moved out from the locking slot 114, and the first end is an end of the shell 110 deviated from the power taking port 21;

the handle 500 is provided with a first connecting portion, an axle hole passes through the first connecting portion, a connecting shaft 600 passes through the axle hole, and two ends of the connecting shaft 600 pass through two opposite sides of the first end.

In an embodiment, the vehicle-mounted charger 10 includes a charger body 100 and a conductive clip 300 matched with the charger body 100; the charger body 100 includes a shell 110 and a charging interface 120, the charging interface 120 being embedded into a first end of the shell 110, the shell 110 being further provided with a circuit board 200, and the charging interface 120 being mounted on the circuit board 200, In the embodiment, the first end of the shell 110 is an end of the shell 110 deviated from a bottom wall of the power taking port 21.

Further, as the shell 110 is capable of being completely inserted into the power taking port 21 of the vehicle-mounted power supply 20, it is ensured that the shell 110 of the vehicle-mounted charger 10 will not protrude out of the end surface of the inlet end of the power taking port 21 when being inserted into the power taking port 21, so that the user is able to better seal the power taking port 21 by fitting the cover body and the end surface of the inlet end of the power taking port 21 when not using the vehicle-mounted charger 10, thereby overcoming the potential safety hazards of the vehicle-mounted power supply 20 in use. Meanwhile, as the shell 110 can be better hidden in the power taking port 21 of the vehicle-mounted power supply 20, the sense of beauty of the whole structure formed by assembling, the vehicle-mounted charger 10 and the vehicle-mounted power supply 20 can be further enhanced.

In the embodiment, an end surface of the first end (the end surface of one end of the shell 110) deviated from a bottom wall of the power taking port 21) of the shell 110 is flush with an end surface of an open end of the power taking port 21 when the shell 110 is inserted into the power taking port 21. It is to be understood that in other embodiments, an end surface of the first end (the end surface of one end of the shell 110) deviated from a bottom wall of the power taking port 21) of the shell 110 is lower than an end surface of an open end of the power taking port 21 when the shell 110 is inserted into the power taking port 21.

In the embodiment, the handle 500 is provided with a first connecting portion, an axle hole passes through the first connecting portion, a connecting shaft 600 passes through the axle hole, and two ends of the connecting shaft 600 pass through two opposite sides of the first end. The handle 500 is rotatably connected with the two opposite ends of the first end via the connecting shaft 600. By increasing the contact area between the handle 500 and the connecting shaft 600, the contact stress between the handle 500 and the connecting shaft 600 is reduced, the risk of failure of the connecting shaft 600 is reduced, and the service life of the handle 500 of the vehicle-mounted charger 10 is prolonged.

In the embodiment, an end surface of the first end is flush with an end surface of an open end of the power taking port 21 when the shell 110 is inserted into the power taking port 21.

In the embodiment, a side wall of the shell 110 is provided with a locking hole 112, the vehicle-mounted charger 10 further including a conductive clip 300, the conductive clip 300 including:

a connecting sheet 310 arranged in the shell 110;

a supporting leg 320 arranged on the connecting sheet 310 and electrically contacted with the charging interface 120; and

a convex block 330 arranged on the connecting sheet 310 and separated from the supporting leg 320, the convex block 330 being clamped in the locking hole 112, protruding out of an outer portion of the shell 110, and being electrically contacted with a power connecting portion 22 of the vehicle-mounted power supply 20.

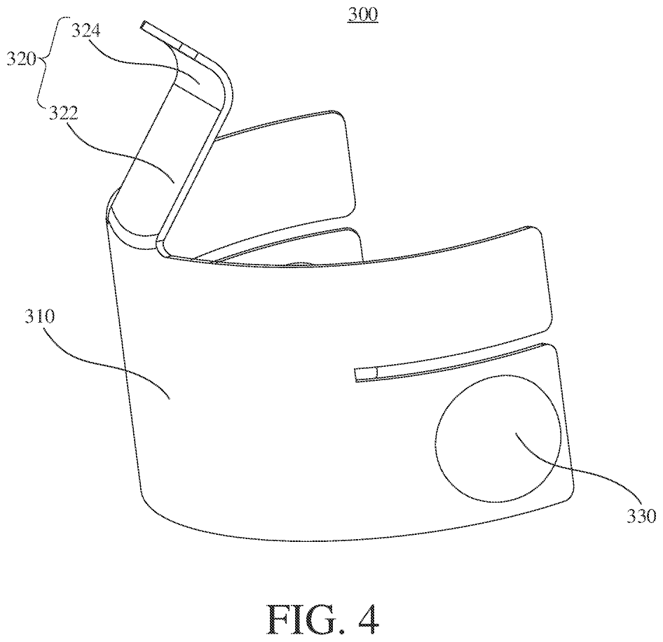

As shown in FIG. 1 and FIG. 4, in an embodiment, a side wall of the shell 110 is provided with a locking hole 112, the conductive clip 300 including a connecting sheet 310, a supporting leg 320 and a convex block 330, where the connecting sheet 310 is arranged in the shell 110; the supporting leg 320 is arranged on the connecting sheet 310 and electrically contacted with the charging interface 120; and the convex block 330 is arranged on the connecting sheet 310 and separated from the supporting leg 320, the convex block 330 is clamped in the locking hole 112, protrudes out of an outer portion of the shell 110, and is electrically contacted with a power connecting portion 22 of the vehicle-mounted power supply 20.

The connecting sheet 310 of the conductive clip 300 is arranged in the shell 110 of the charger body 100, the supporting leg 320 is arranged on the connecting sheet 310 and is electrically contacted with the charging interface 120 embedded into one end of the shell 110 and mounted on the circuit board 200, the convex block 330 is arranged on the connecting sheet 310 and is clamped in the locking hole 112 and protrudes out of the shell 110, and the conductive clip 300 can be electrically contacted with the power connecting portion 22 of the vehicle-mounted power supply 20 via the convex block 330 so as to form an electric connection between the charging interface 120 and the vehicle-mounted power supply 20, thereby supplying power to an electronic product via the charging interface 120. Therefore, the conductive clip 300 can be relatively fixed to the shell 110 without being welded to the circuit board 200 by means of clamping fit between the convex block 330 and the locking hole 112. It is convenient to mount and reliable and stable. Meanwhile, a processing technology can be simplified and the production cost can be lowered.

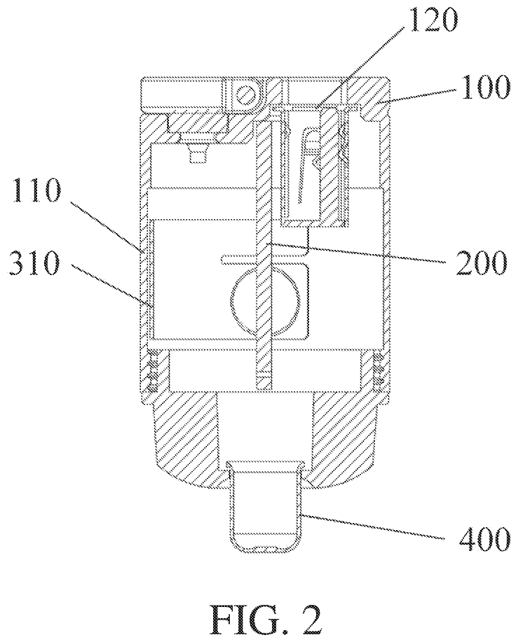

In the embodiment, the supporting leg 320 is obliquely arranged towards a direction close to an axis of the shell 110. As shown in FIG. 2 to FIG. 4, in an embodiment, the connecting sheet 310 fits an inner side wall of the shell 110. In the embodiment, the connecting sheet 310 is arc-shaped, the shape of the connecting sheet 310 is matched with a contour of the inner side wall of the shell 110, so that the connecting sheet 310 can better fit the inner side wall of the shell 110.

In the embodiment, the supporting leg 320 includes a first supporting portion 322 and a second supporting portion 324, the first supporting portion 322 being connected with the connecting sheet 310 and being obliquely arranged towards a direction close to the axis of the shell 110, and the second supporting portion 324 being connected with an end of the first supporting portion 322 away from the connecting sheet 310 and being obliquely arranged towards a direction away from the axis of the shell 110. The supporting leg 320 includes the first supporting portion 322 and the second supporting portion 324, the first supporting portion 322 being connected with the connecting sheet 310 and being obliquely arranged towards a direction close to the axis of the shell 110, and the second supporting portion 324 being connected with an end of the first supporting portion 322 away from the connecting sheet 310 and being obliquely arranged towards a direction away from the axis of the shell 110. A connection between the second supporting portion 324 and the first supporting portion 322 is electrically contacted with the charging interface 120.

In the embodiment, there are two convex blocks 330 and two locking holes 112, the two convex blocks 330 being oppositely arranged at two ends of the connecting sheet 310 and being in one-to-one correspondence with the two locking holes 112. The connecting sheet 310, the convex blocks 330 and the supporting leg 320 are integrally formed, so that the conductive clip 300 is integrally machined.

In the embodiment, the power connecting portion 22 of the vehicle-mounted power supply 20 includes a negative power connecting portion and a positive power connecting portion, and the convex block 330 is electrically contacted with the negative power connecting portion of the vehicle-mounted power supply 200A shown in FIG. 1, FIG. 2 and FIG. 4, further, the power connecting portion 22 of the vehicle-mounted power supply 20 includes the negative power connecting portion 22 and the positive power connecting portion 22, and the convex blocks 330 are electrically contacted with the negative power connecting portion 22 of the vehicle-mounted power supply 20. The vehicle-mounted charger 10 further includes a conductive head 400 arranged at a second end of the shell 110 and electrically connected with the circuit board 200, the conductive head 400 being electrically contacted with the positive power connecting portion 22 of the vehicle-mounted power supply 20. The negative power connecting portion 22 of the vehicle-mounted power supply 20 and the positive power connecting portion 22 of the vehicle-mounted power supply 20 are both arranged in the power taking portion 21 of the vehicle-mounted power supply 20.

Specifically, when the vehicle-mounted charger 10 is used, the shell 110 is inserted into the power taking port 21 of the vehicle-mounted power supply 20. As the conductive clip 300 is elastic, the convex blocks 330 thereof will be extruded by the inner side wall of the power taking port 21, so that the convex blocks 330 shrink towards the inner side of the shell UR When being inserted into the corresponding position of the power taking port 21 of the vehicle-mounted power supply 20, the convex blocks 330 will elastically abut against the negative power connecting portion 22 of the vehicle-mounted power supply 20 to form electric contact, and meanwhile, the supporting leg 320 of the conductive clip 300 is electrically contacted with the charging interface 120 arranged on the circuit board 200, a current signal is transferred to the circuit board 200, the circuit board 200 is electrically connected with the conductive head 400, and the conductive head 400 is then electrically contacted with the negative connecting portion 22 of the vehicle-mounted power supply 20 to form a circuit. At the moment, the charging interface 120 arranged on the circuit board 200 can supply power to the electronic product. It is to be noted that in the embodiment, there are two negative connecting portions 22 of the vehicle-mounted power supply 20, and the two convex blocks 330 correspond to the two negative connecting portions 22 of the vehicle-mounted power supply 20 one to one.

In the embodiment, the vehicle-mounted charger 10 further includes the conductive head 400 arranged at the second end of the shell 110 and electrically connected with the circuit board 200, the conductive head 400 being electrically contacted with the positive connecting portion of the vehicle-mounted power supply 20.

In the embodiment, the negative power connecting portions of the vehicle-mounted power supply 20 and the positive power connecting portion of the vehicle-mounted power supply 20 are both arranged in the power taking portion 21 of the vehicle-mounted power supply 20.

In the embodiment, the vehicle-mounted charger 10 further includes an indicating lamp 700 arranged at one end of the shell 110 and electrically connected with the circuit board 200, the indicating lamp 700 being used for displaying an electric connection state between the electronic product and the charging interface 120.

Finally, it is to be further noted that the relationship terms herein such as first and second are merely used for differentiating one body or operation from another body or operation rather than requiring or hinting any actual relationship or sequence among the bodies or operations. Further, the terms “include”, “comprise” or any other variants are intended to cover non-excludable inclusions, such that a process, method, article or apparatus including a series of elements not only include these elements, but also further include other elements which are not listed obviously or further include inhered elements of the process, method, article or terminal equipment. Without more restrictions, elements defined by a sentence “including one” do not exclude additional same elements in the process, method, article or Terminal equipment including the elements.

Detailed introduction is made above on the vehicle-mounted charger provided by the application. Particular examples are used herein to explain the principle and embodiments of the application, and the above description of the embodiments is only used to help understanding the methods and core concept of the application; and meanwhile, alternations will be made by those skilled in the technical field on the specific embodiments and application range in accordance with thought of the present invention. In conclusion, the content of the description shall not be construed as limitation to the application.

1. A vehicle-mounted charger, comprising a shell, a charging interface, a circuit board and a handle, wherein the shell is capable of being completely inserted into a power taking port of a vehicle-mounted power supply, the charging interface is embedded into a first end of the shell, the circuit board is mounted in the shell and is connected with the charging interface, the first end of the shell is provided with a locking slot, the handle is rotatably arranged at the first end and is capable of being completely moved in and clamped into the locking slot or being moved out from the locking slot via its own rotation, and the first end is an end of the shell deviated from the power taking port;
the handle is provided with a first connecting portion, an axle hole passes through the first connecting portion, a connecting shaft passes through the axle hole, and two ends of the connecting shaft pass through two opposite sides of the first end.

2. The vehicle-mounted charger according to claim 1, wherein an end surface of the first end is flush with an end surface of an open end of the power taking port when the shell is inserted into the power taking port.

3. The vehicle-mounted charger according to claim 1, wherein a side wall of the shell is provided with a locking hole, the vehicle-mounted charger further comprising a conductive clip, the conductive clip comprising:
a connecting sheet arranged in the shell;
a supporting leg arranged on the connecting sheet and electrically contacted with the charging interface; and
a convex block arranged on the connecting sheet and separated from the supporting leg, the convex block being clamped in the locking hole, protruding out of an outer portion of the shell, and being electrically contacted with a power connecting portion of the vehicle-mounted power supply.

4. The vehicle-mounted charger according to claim 3, wherein the supporting leg is obliquely arranged towards a direction close to an axis of the shell.

5. The vehicle-mounted charger according to claim 4, wherein the supporting leg comprises a first supporting portion and a second supporting portion, the first supporting portion being connected with the connecting sheet and being obliquely arranged towards a direction close to the axis of the shell, and the second supporting portion being connected with an end of the first supporting portion away from the connecting sheet and being obliquely arranged towards a direction away from the axis of the shell.

6. The vehicle-mounted charger according to claim 5, wherein a connection between the second supporting portion and the first supporting portion is electrically contacted with the charging interface.

7. The vehicle-mounted charger according to claim 3, wherein there are two convex blocks and two locking holes, the two convex blocks being oppositely arranged at two ends of the connecting sheet and being in one-to-one correspondence with the two locking holes.

8. The vehicle-mounted charger according to claim 3, wherein the power connecting portion of the vehicle-mounted power supply comprises a negative power connecting portion and a positive power connecting portion, and the convex block is electrically contacted with the negative power connecting portion of the vehicle-mounted power supply.

9. The vehicle-mounted charger according to claim 8, the vehicle-mounted charger further comprising a conductive head arranged al a second end of the shell and electrically connected with the circuit board, the conductive head being electrically contacted with the positive power connecting portion of the vehicle-mounted power supply.

10. The vehicle-mounted charger according to claim 9, wherein the negative power connecting portion of the vehicle-mounted power supply and the positive power connecting portion of the vehicle-mounted power supply are both arranged in the power taking portion of the vehicle-mounted power supply.
